(19) United States
(12) Patent Application Publication
(10) Pub. No.: US 2009/0158161 A1
(43) Pub. Date: Jun. 18, 2009

(54) COLLABORATIVE SEARCH IN VIRTUAL WORLDS

(75) Inventors: Simon J. Gibbs, San Jose, CA (US); Mithun Sheshagiri, San Francisco, CA (US)

Correspondence Address: Beyer Law Group LLP, P.O. BOX 1687, Cupertino, CA, 95015-1687, US

(73) Assignee: SAMSUNG ELECTRONICS CO., LTD., Suwon City (KR)

(21) Appl. No.: 11/959,266

(22) Filed: Dec. 18, 2007

(51) Int. Cl. G06F 3/00; G06F 17/00; G06F 17/30

(52) U.S. Cl. 715/733; 707/100; 707/3; 715/700; 707/E17.005

(57) ABSTRACT

In a first embodiment, first information regarding an object in a virtual world is received from a virtual world client. The first information is stored in a database. Second information regarding the object is received from a second virtual world client. The second information is then also stored in the database. In a second embodiment, a request is received from a virtual world client. Then a database is searched based on the request and based on tags corresponding to virtual world objects, wherein the tags are stored in the database, wherein the searching returns one or more tagged virtual world objects. Then the one or more tagged virtual world objects are sent to the virtual world client.

### BACKGROUND OF THE INVENTION

1. Field of the Invention

The present invention relates to virtual worlds. More particularly, the present invention relates to collaborative searches in virtual worlds.

2. Description of the Related Art

Virtual Worlds are computer-based simulations wherein multiple users interact with each other and with objects within the world via a graphical user interface. Users of the virtual world may be interconnected via the Internet and/or other communications mediums and protocols, such as Voice over IP (VoIP).

In a virtual world, a user is typically represented by an avatar, or a virtual representation of the user. This avatar typically takes the form of a semi-realistic being, such as a human or animal, which the user can control using various navigational commands. Through the control of this avatar, the user can interact with other users and perform actions within the world, such as fighting, picking up objects, and using objects, among many others.

### SUMMARY OF THE INVENTION

In a first embodiment, first information regarding an object in a virtual world is received from a virtual world client. The first information is stored in a database. Second information regarding the object is received from a second virtual world client. The second information is then also stored in the database. In a second embodiment, a request is received from a virtual world client. Then a database is searched based on the request and based on tags corresponding to virtual world objects, wherein the tags are stored in the database, wherein the searching returns one or more tagged virtual world objects. Then the one or more tagged virtual world objects are sent to the virtual world client.

### BRIEF DESCRIPTION OF THE DRAWINGS

FIG. 1 is a screen capture of a virtual world in accordance with an embodiment of the present invention.

FIG. 2 is another screen capture of a virtual world in accordance with an embodiment of the present invention.

FIG. 3 is another screen capture of a virtual world in accordance with an embodiment of the present invention.

FIG. 4 is another screen capture of a virtual world in accordance with an embodiment of the present invention.

FIG. 5 is a block diagram illustrating a virtual world system in accordance with an embodiment of the present invention.

FIG. 6 is a block diagram illustrating a virtual world system in accordance with another embodiment of the present invention.

FIG. 7 is a block diagram illustrating a virtual world system in accordance with another embodiment of the present invention.

FIG. 8 is a process diagram illustrating recording and utilizing tags in a virtual world in accordance with an embodiment of the present invention.

FIG. 9 is a flow diagram illustrating a method for tagging a virtual world object in accordance with an embodiment of the present invention.

FIG. 10 is a flow diagram illustrating a method for utilizing tagged virtual world objects in accordance with an embodiment of the present invention.

FIG. 11 is a flow diagram illustrating a method for utilizing tagged virtual world objects in accordance with an embodiment of the present invention.

FIG. 12 is a flow diagram illustrating a method for indexing tagged virtual world objects in accordance with an embodiment of the present invention.

FIG. 13 is a flow diagram illustrating a method for conducting a search of a virtual world database in accordance with an embodiment of the present invention.

FIG. 14 is a flow diagram illustrating a method for conducting a search of a virtual world database in accordance with an embodiment of the present invention.

FIG. 15 is a flow diagram illustrating a method for managing a database of virtual world objects in accordance with an embodiment of the present invention.

FIG. 16 is a flow diagram illustrating a method for managing a database of virtual world objects in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In an embodiment of the present invention, conducting searches in a virtual world is improved through the use of collaboration with other users. Specifically, an embodiment of the present invention allows users to “tag” various objects in a virtual world with metadata. This metadata may include, for example, an indication that a user likes the objects, more detailed information about the objects than the virtual world provides (such as dimensions, special features, etc.), reviews of the objects, or any other information that the user believes may be useful to other users (or to him or herself). This tag may be stored by a virtual world server. When other users then conduct searches in the virtual world, these tags may be accessed and metadata relevant to the search query may be utilized in presenting results.

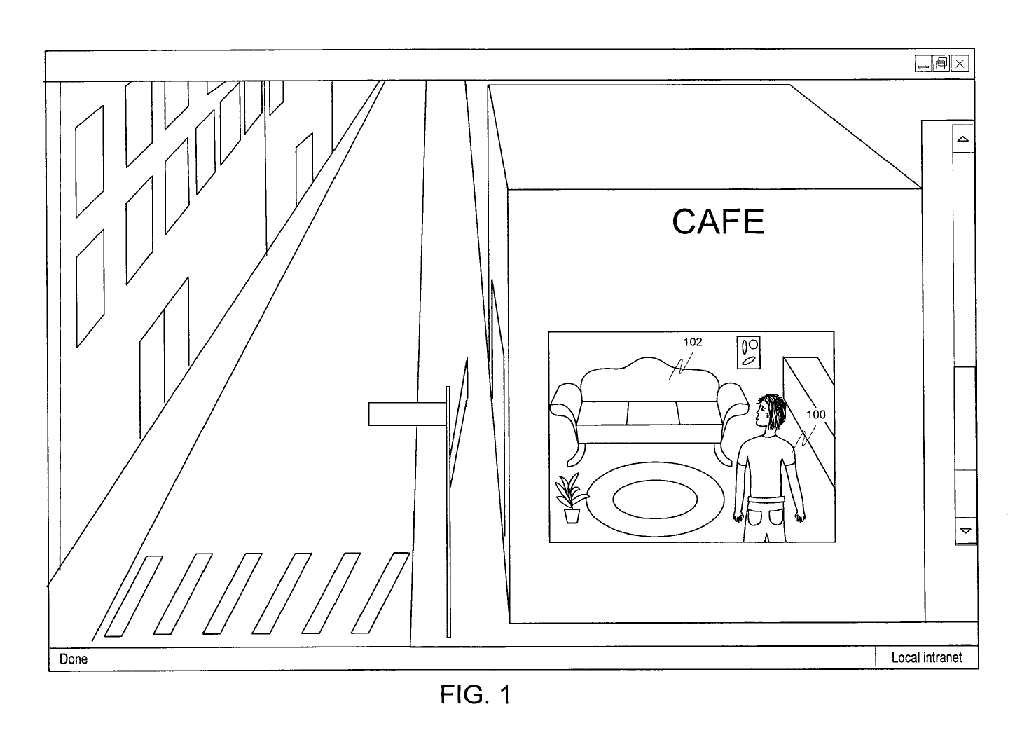

FIG. 1 is a screen capture of a virtual world in accordance with an embodiment of the present invention. Here, a user's avatar 100 has encountered an object 102. The user may have at his or her disposal some information about the object 102 that is not currently available to the virtual world. This information may take many forms, depending on the amount of type of information the virtual world already has about the object. A virtual world environment may know very little about certain objects. In such cases, the information the user may wish to share with others may be as simple as a label or basic description of the object. For example, if the object 102 is a couch, the information the user wishes to share may simply be the label “couch,” or “red couch,” or “red modern couch with black accents,” for example. If the virtual world already has such basic information, the user may wish to share more detailed information about the object, such its properties (“soft couch.,” “couch model number A5273,” or “6 foot wide couch.” The user may also wish to share subjective information about the object, such as “ugly couch,” “couch rating of 7 out of 10”, or even a detailed review of the object.

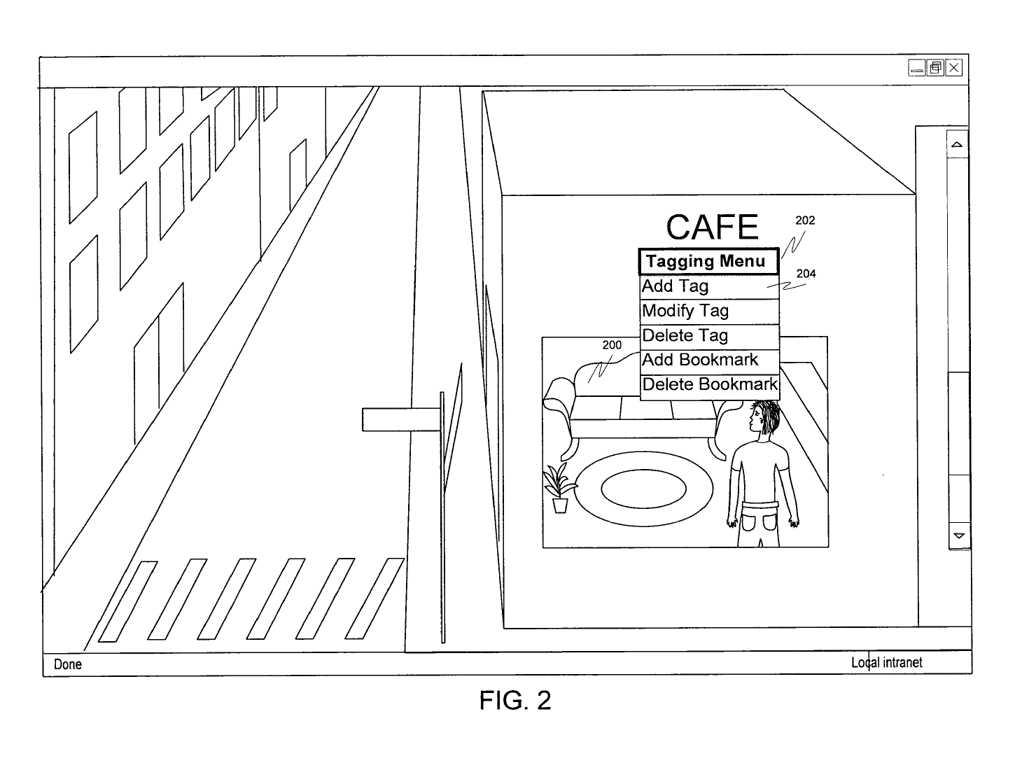

FIG. 2 is another screen capture of a virtual world in accordance with an embodiment of the present invention. Here, the user has right-clicked on the object 200 in order to bring up a tagging menu 202. Right-clicking is the process of moving a cursor with a mouse to a particular location and depressing the right mouse button. This is merely an example of a navigation command that may be invoked by the user, and one of ordinary skill in the art will recognize that any type of command may be used to activate the tagging menu 202.

Tagging menu 202 may provide a series of choices relating to the tagging of the object by the user. The user may select one of these actions and thus create or modify a tag for the object 200. Here the user has selected “add tag” 204.

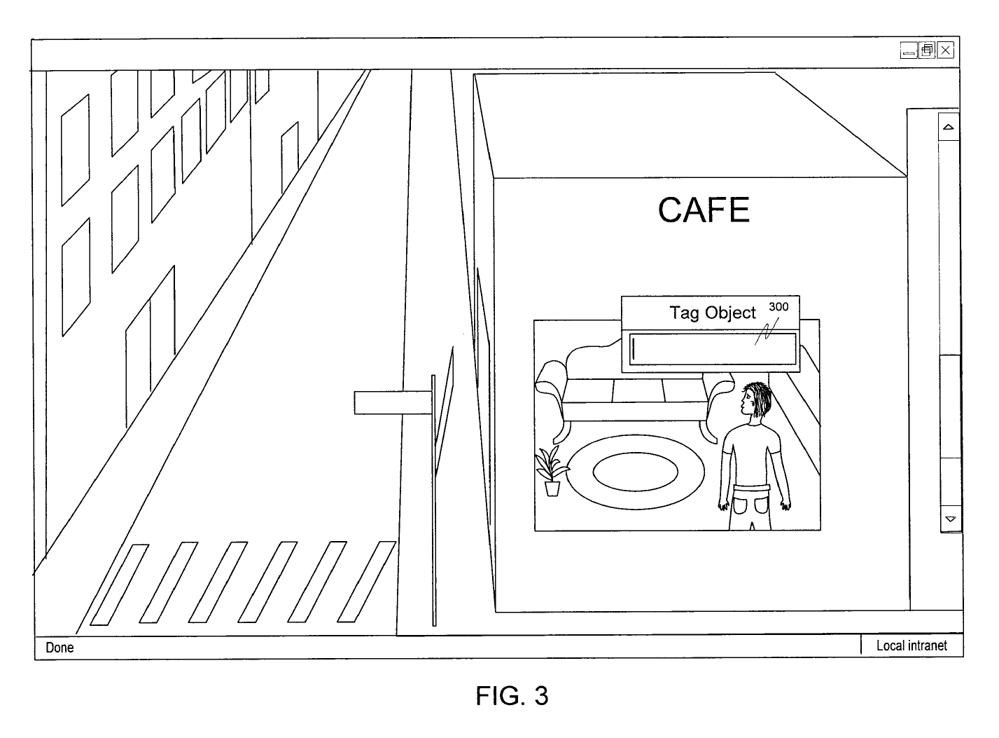

FIG. 3 is another screen capture of a virtual world in accordance with an embodiment of the present invention. Here, in response to the user selecting “add tag,” a tag object text box 300 has appeared allowing the user to enter a textual tag to the object.

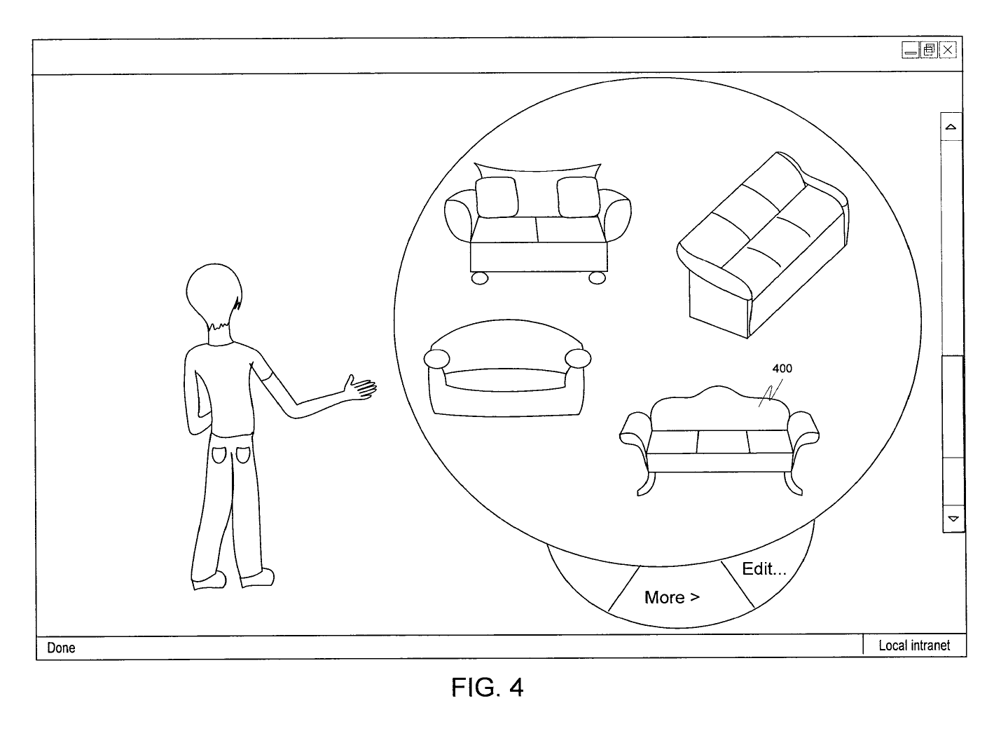

FIG. 4 is another screen capture of a virtual world in accordance with an embodiment of the present invention. Here, another user with a different avatar 400 has performed a search on the term “red sofa”. In response to this, the virtual world client has transmitted the search parameters to a search aggregation service, which returns various objects that match the search parameters. Among them is object 402 that was previously tagged as “red sofa” in FIGS. 1-3 above. Thus, the user in FIGS. 1-3 has provided information about the object that was used to respond to a search by the user in FIG. 4. FIG. 4 depicts the search results being presented graphically (depicting the objects themselves in contrast to textual search results merely listing or describing the objects).

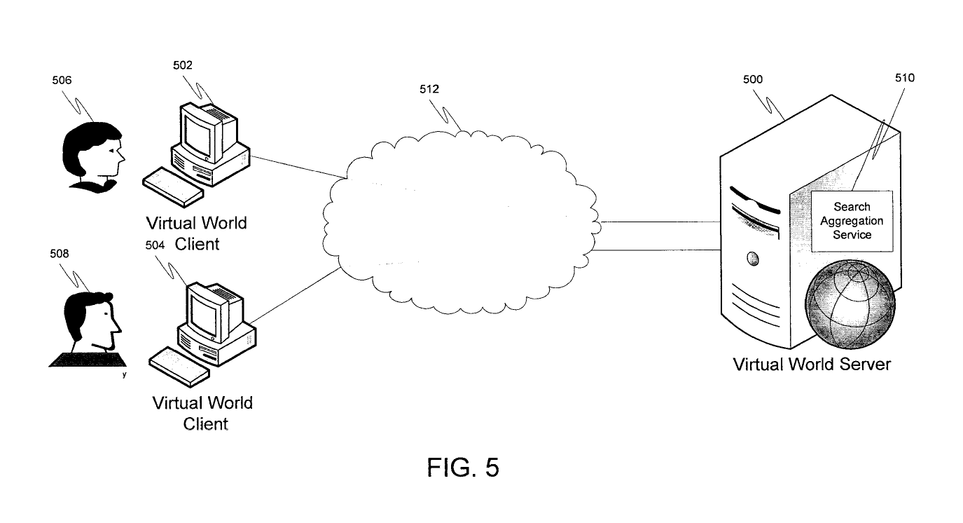

FIG. 5 is a block diagram illustrating a virtual world system in accordance with an embodiment of the present invention. Here, a virtual world server 500 operates the virtual world. One of ordinary skill in the art will recognize that while one server 500 is depicted in this figure, the server functions may be distributed over many different servers. As such, for purposes of this document, the term “server” shall not be construed to be limited to a single server implementation but may cover any combination of servers that perform the function of a server.

There are also a plurality of virtual world clients 502, 504 located on client machines. These client machines may be operated by users 506, 508. In an embodiment of the present invention, the virtual world clients 502, 504 may be modified to include specialized functionality to enable the tagging of objects in the virtual world. This may be implemented via, for example, the use of user-defined scripts, as many virtual world clients permit users to run customized actions by defining scripts to be performed upon the occurrence of certain actions.

A search aggregation service (SAS) 510 may be included on server 500. This service may manage and store the tags on the objects as well as perform aspects of searches requested by users.

It should be noted that the exact division of responsibilities between the SAS 510 and the virtual world clients 502, 504 may vary greatly depending upon implementation. In some systems, it might be preferable for the virtual world clients to utilize little memory and processing power, hence making it more beneficial to maintain many of the responsibilities on the server-side. Such implementations may become more common as computing devices other than traditional computers are used to operate virtual world clients. For example, embodiments wherein virtual world clients are operated on cellular phones are envisioned. The limiting processing power and memory of such phones make it likelier that the server 500 will maintain most of the responsibilities for the tagging and searching systems. Embodiments where client-side functionality is limited are commonly known as “thin clients” or “dumb clients.”

Alternatively, many of the responsibilities for the tagging and/or searching functions may be maintained by the virtual world clients 502, 504. Embodiments where client-side functionality is expanded are commonly known as “thick clients” or “smart clients.” These types of embodiments resemble distributing computing environments, and reduce the load on server 500 as well as minimize bandwidth usage through network 512.

The functions performed by the virtual world clients 502, 504 and the SAS 514 will be described in more detail below.

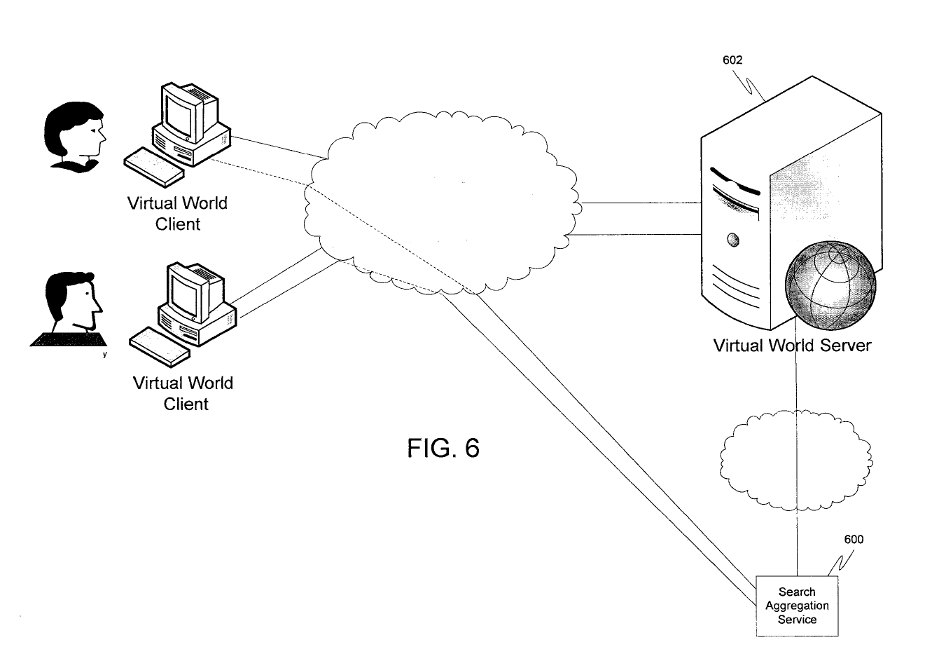

It should be noted that the embodiment in FIG. 5 would be most commonly used where the company or organization that operates the virtual world also operates the SAS. Embodiments are foreseen, however, wherein the SAS is operated by a third party company or organization. In such embodiments, direct cooperation with the server 500 may be limited or even absent entirely. FIG. 6 is a block diagram illustrating a virtual world system in accordance with another embodiment of the present invention. In this embodiment, SAS 600 is operated separately from server 602, but still maintains some level of cooperation with server 602. This embodiment may be most commonly used where the SAS is operated by a third party company or organization but where this company or organization is a partner of or otherwise authorized by the company or organization that operates the server 602. This embodiment may also be common where the server 602 communicates via an open protocol that the SAS 600 may utilize even though the third party company or organization operating the SAS 600 may not be a partner of or otherwise authorized by the company or organization that operates the server 602.

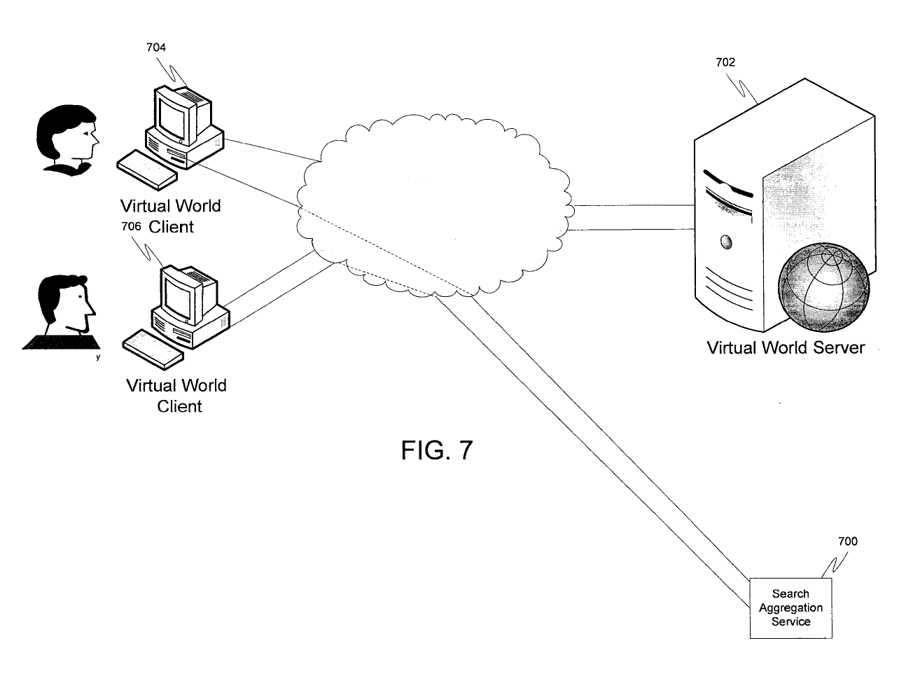

FIG. 7 is a block diagram illustrating a virtual world system in accordance with another embodiment of the present invention. In this embodiment, SAS 700 is operated separately from server 702 and does not communicate directly with server 702. Such an embodiment may be most common where the company or organization that operates the SAS 700 is not a partner of or authorized by the company or organization that operates the server 702, and where server 702 does not communicate via an open protocol. In such an implementation, any interaction that is desired between the SAS 700 and server 702 may take place using the virtual world client 704, 706 as an intermediary.

In an embodiment of the present invention, a user may simply choose to “bookmark” an object as opposed to tagging it. The difference between bookmarking and tagging is that bookmarking simple records the fact that the user finds the object interesting, whereas tagging results in the user actually providing some information to be recorded with or about the object.

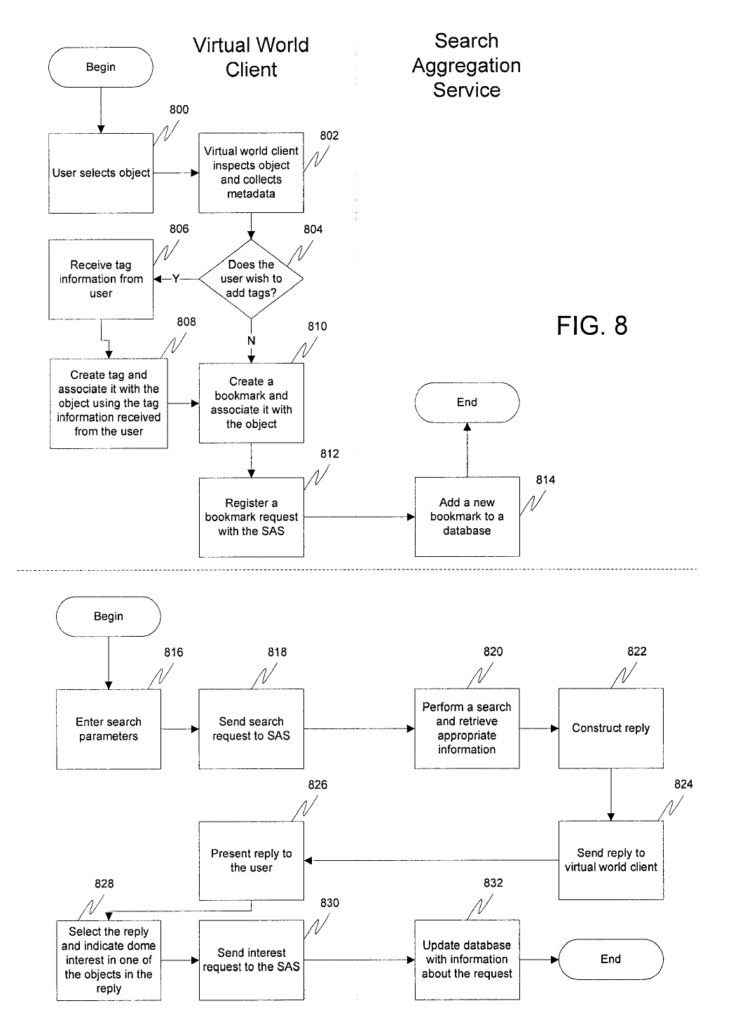

FIG. 8 is a process diagram illustrating recording and utilizing tags in a virtual world in accordance with an embodiment of the present invention. At a virtual world client, at 800 a user may select an object. This may include, for example, right-clicking or otherwise navigating to and highlighting the object. At 802, the virtual world client may inspect the object and collect metadata. This may include, for example, the object identification and location. At 804, it may be determined if the user wishes to add user tags. This may be determined by, for example, examining the commands initiated by the user. A menu may be provided to the user when selecting the object that allows the user to indicate whether to tag the object, bookmark the object, or perform some other task. If the user wishes to tag them object, then at 806 tag information may be received from the user. This information may include whatever information the user wishes to include in the tag. Alternatively, the user may simply provide a link or other dynamic pointer to where the information may be retrieved. At 808, a tag may be created and associated with the object using the tag information received from the user. At 810, a bookmark may be created and associated with the object. At 812, the virtual world client may register a bookmark request with the SAS. This may include sending the SAS the name of the avatar, the object identification, the object location, and the created tag(s) for the object.

At 814, the SAS may add a new bookmark to a database. This database may contain object tags and locations.

At a later time, another virtual world client may wish to perform a search. Search parameters may be entered on the virtual world client at 816. The search request may then be sent to the SAS at 818 and the SAS may perform the search at 820 by accessing the database and retrieving appropriate information. At 822, a reply may be constructed. This search reply may be sent to the virtual world client at 824 and may include, for example, coordinates of matching objects and associated metadata. At 826, the reply may be presented to the user. At 828, the user may select the reply and may indicate some interest in one of the objects in the reply. At 830 the interest request may be sent to the SAS and at 832 the SAS may update the database with the information about the interest. The tracking of user interest allows for valuable feedback to be collected regarding the search (e.g., how effective it was) as well as providing a mechanism for the user to rate the object itself and the initial user's decision to bookmark and/or tag the object.

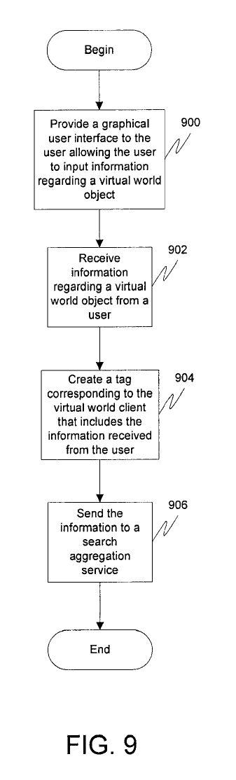

FIG. 9 is a flow diagram illustrating a method for tagging a virtual world object in accordance with an embodiment of the present invention. This embodiment may be executed on a virtual world client. Each step in this method may be embodied in hardware, software, or any combination thereof. At 900, a graphical user interface may be provided to the user allowing the user to input information regarding a virtual world object. This interface may be, for example, a menu that appears when the user right-clicks on an object in the virtual world, and a text box for entering information once an appropriate menu entry is selected. At 902, information regarding a virtual world object is received from a user. At 904, a tag corresponding to the virtual world client may be created that includes the information received from the user. This step is optional, however, as embodiments are possible wherein the tag itself is created by the search aggregation service, not the virtual world client. At 906, the information is sent to a search aggregation service. This information may take the form of the tag if step 902 was performed by the virtual world client.

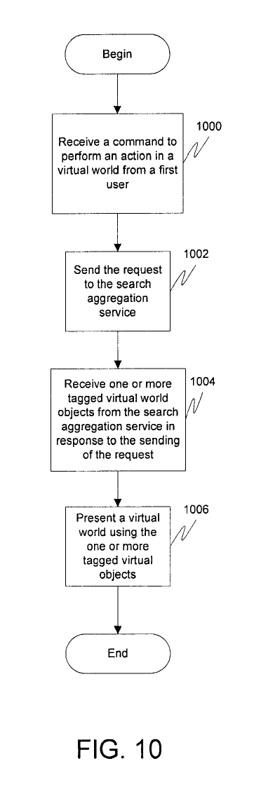

FIG. 10 is a flow diagram illustrating a method for utilizing tagged virtual world objects in accordance with an embodiment of the present invention. This embodiment may be executed on a thin (i.e., dumb) virtual world client. Each step in this method may be embodied in hardware, software, or any combination thereof. At 1000, a command to perform an action in a virtual world is received from a first user. This action may be, for example, performing a text-based search for one or more virtual world objects, navigating an avatar associated with the user to a particular location in the virtual world, selecting an object in the virtual world, etc. At 1002, a request is sent to a search aggregation service. This request may include, for example, virtual world object search parameters, a location of an avatar associated with the user in the virtual world, an automatic query generated by virtue of a location of an avatar associated with the user in the virtual world, an object identification of a virtual world objects selected by the user, an automatic query generated by virtue of an object identification of a virtual world objects selected by the user, etc. The request may also include a user profile for the user. At 1004, one or more tagged virtual world objects are received from the search aggregation service in response to the sending of the request. The tagged virtual world objects may have been tagged by a second user utilizing a different virtual world client than the first user. At 1006, a virtual world may be presented to the user using the one or more tagged virtual objects. The tagged virtual world objects may be presented, for example, as graphics in a virtual world menu, by highlighting the one or more tagged virtual world objects in the virtual world, etc. In an additional embodiment, customized advertisements may be presented in the virtual world based on one or more tags of the one or more tagged virtual world objects. This includes basing the advertising selection on, for example, the name of the tagged objects, the location of the tagged objects, the popularity of the tagged objects, etc.

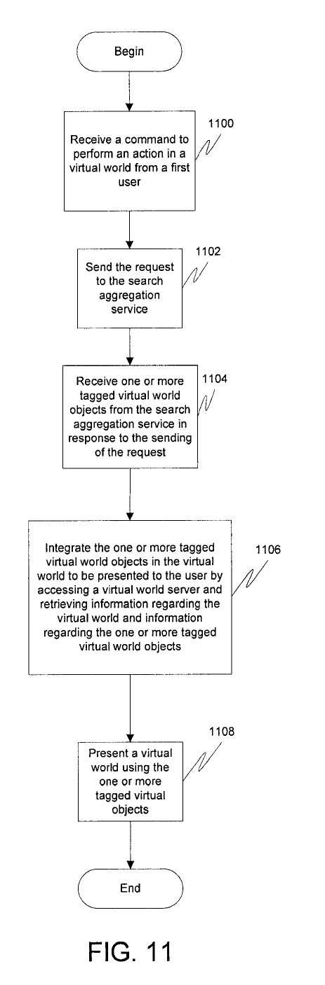

FIG. 11 is a flow diagram illustrating a method for utilizing tagged virtual world objects in accordance with an embodiment of the present invention. This embodiment may be executed on a thick (i.e., smart) virtual world client. Each step in this method may be embodied in hardware, software, or any combination thereof. This embodiment is similar to the embodiment of FIG. 10, except for the inclusion of step 1106. At 1100, a command to perform an action in a virtual world is received from a first user. At 1102, a request is sent to a search aggregation service. The request may also include a user profile for the user. At 1104, one or more tagged virtual world objects are received from the search aggregation service in response to the sending of the request. At 1106, the one or more tagged virtual world objects may be integrated in the virtual world to be presented to the user by accessing a virtual world server and retrieving information regarding the virtual world and information regarding the one or more tagged virtual world objects. At 1108, a virtual world may be presented to the user using the one or more tagged virtual objects.

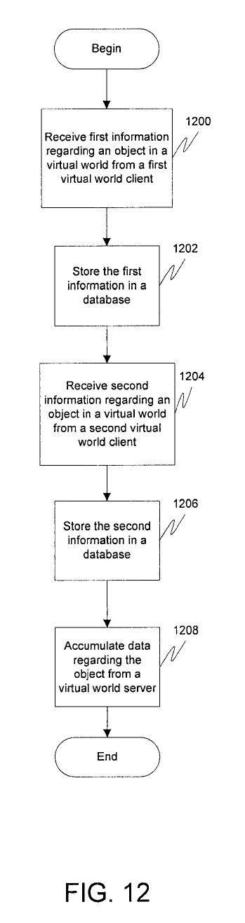

FIG. 12 is a flow diagram illustrating a method for indexing tagged virtual world objects in accordance with an embodiment of the present invention. This embodiment may be executed on a search aggregation service. Each step in this method may be embodied in hardware, software, or any combination thereof. At 1200, first information regarding an object in a virtual world is received from a first virtual world client. This information may include a tag for the object. Alternatively, a tag may be created for the object by the search aggregation service. At 1202, the first information is stored in a database. At 1204, second information regarding the object is received from a second virtual world client. This information may include a tag for the object. Alternatively, a tag may be created for the object by the search aggregation service. At 1206, the second information may be stored in the database. In one embodiment, the search aggregation service operates separately and independently from the virtual world server. In another embodiment, at, 1208, data regarding the object may be accumulated from a virtual world server. This embodiment may include either the search aggregation service running from within the virtual world server or the search aggregation service operating separately from the virtual world server, but in cooperation with the virtual world server.

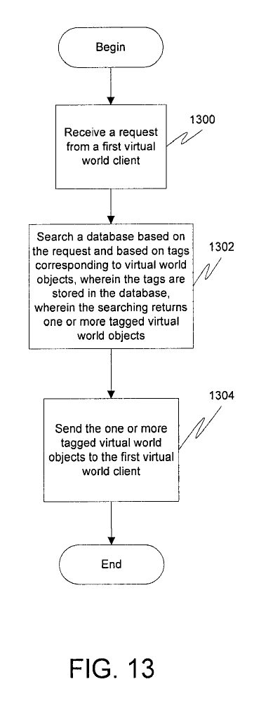

FIG. 13 is a flow diagram illustrating a method for conducting a search of a virtual world database in accordance with an embodiment of the present invention. This embodiment may be executed on a search aggregation service utilized by thick (i.e., smart) clients. Each step of this method may be embodied in hardware, software, or any combination thereof. At 1300, a request is received from a first virtual world client. This request may include a database query. Alternatively, the search aggregation service may generate a query using information from the request. At 1302, a database is searched based on the request and based on tags corresponding to virtual world objects, wherein the tags are stored in the database, wherein the searching returns one or more tagged virtual world objects. The tags may have been stored in the database in response to information provided by one or more virtual world clients other than the first virtual world client. At 1304, the one or more tagged virtual world objects may be sent to the first virtual world client.

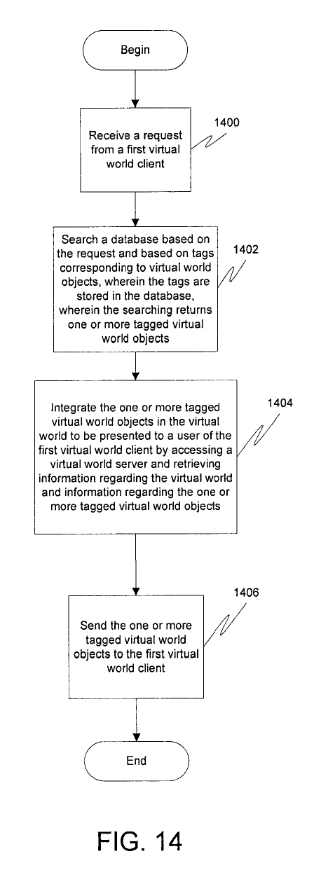

FIG. 14 is a flow diagram illustrating a method for conducting a search of a virtual world database in accordance with an embodiment of the present invention. This embodiment may be executed on a search aggregation service utilized by thin (i.e., dumb) clients. Each step of this method may be embodied in hardware, software, or any combination thereof. This method is similar to that of FIG. 13, except for the inclusion of step 1404. At 1400, a request is received from a first virtual world client. This request may include a database query. Alternatively, the search aggregation service may generate a query using information from the request. At 1402, a database is searched based on the request and based on tags corresponding to virtual world objects, wherein the tags are stored in the database, wherein the searching returns one or more tagged virtual world objects. The tags may have been stored in the database in response to information provided by one or more virtual world clients other than the first virtual world client. At 1404, the one or more tagged virtual world objects may be integrated in a virtual world to be presented to a user of the first virtual world client by accessing a virtual world server and retrieving information regarding the virtual world and information regarding the one or more tagged virtual world objects. At 1406, the one or more tagged virtual world objects may be sent to the first virtual world client.

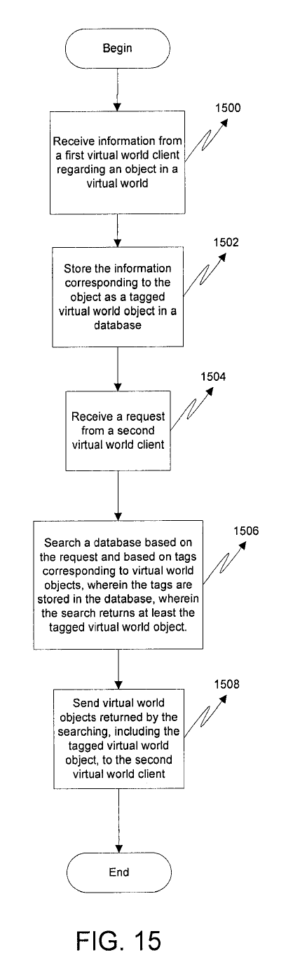

FIG. 15 is a flow diagram illustrating a method for managing a database of virtual world objects in accordance with an embodiment of the present invention. This embodiment may be executed on a search aggregation service utilized by thick (i.e., smart) clients. Each step of the method may be embodied in hardware, software, or any combination thereof. At 1500, information is received from a first virtual world client regarding an object in a virtual world. This information may include a tag for the object. Alternatively, a tag may be created for the object by the search aggregation service. At 1502, the information corresponding to the object is stored as a tagged virtual world object in a database. At 1504, a request is received from a second virtual world client. This request may include a database query. Alternatively, the search aggregation service may generate a query using information from the request. At 1506, a database is searched based on the request and based on tags corresponding to virtual world objects, wherein the tags are stored in the database, wherein the search returns at least the tagged virtual world object. At 1508, virtual world objects returned by the searching, including the tagged virtual world object, are sent to the second virtual world client.

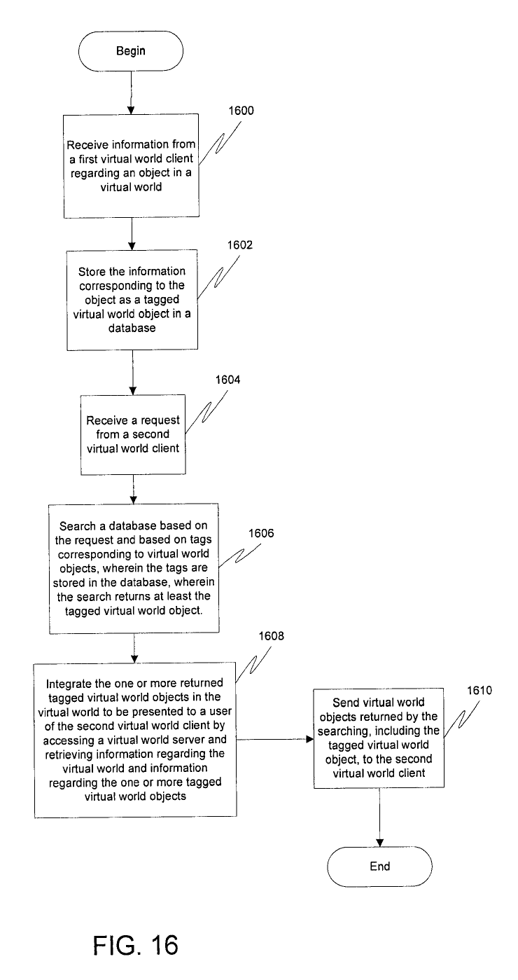

FIG. 16 is a flow diagram illustrating a method for managing a database of virtual world objects in accordance with an embodiment of the present invention. This embodiment may be executed on a search aggregation service utilized by thin (i.e., dumb) clients. Each step of the method may be embodied in hardware, software, or any combination thereof. This method is similar to that of FIG. 15 except for the inclusion of step 1608. At 1600, information is received from a first virtual world client regarding an object in a virtual world. This information may include a tag for the object. Alternatively, a tag may be created for the object by the search aggregation service. At 1602, the information corresponding to the object is stored as a tagged virtual world object in a database. At 1604, a request is received from a second virtual world client. This request may include a database query. Alternatively, the search aggregation service may generate a query using information from the request. At 1606, a database is searched based on the request and based on tags corresponding to virtual world objects, wherein the tags are stored in the database, wherein the search returns at least the tagged virtual world object. At 1608, the one or more returned tagged virtual world objects may be integrated in a virtual world to be presented to the second virtual world client by accessing a virtual world server and retrieving information regarding the virtual world and information regarding the one or more tagged virtual world objects. At 1610, virtual world objects returned by the searching, including the tagged virtual world object, are sent to the second virtual world client.

Where the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method comprising:
receiving, from a first virtual world client, first information regarding an object in a virtual world;
storing the first information in a database;
receiving, from a second virtual world client, second information regarding the object; and
storing the second information in the database.

2. The method of claim 1, wherein the first information includes a tag for the object.

3. The method of claim 1, further comprising creating a tag for the object and linking the tag to the object in a database.

4. The method of claim 1, further comprising:
accumulating data regarding the object from a virtual world server.

5. A method comprising:
receiving a request from a virtual world client;
searching a database based on the request and based on tags corresponding to virtual world objects, wherein the tags are stored in the database, wherein the searching returns one or more tagged virtual world objects; and
sending the one or more tagged virtual world objects to the virtual world client.

6. The method of claim 5, further comprising generating a database query from the request.

7. The method of claim 5, wherein the request includes a database query.

8. The method of claim 5, wherein the tags were stored in the database in response to information provided by one or more other virtual world clients.

9. The method of claim 5, further comprising:
integrating the one or more tagged virtual world objects in a virtual world to be presented to a user of the virtual world client by accessing a virtual world server and retrieving information regarding the virtual world and information regarding the one or more tagged virtual world objects.

10. A method comprising:
receiving, from a first virtual world client, information regarding an object in a virtual world;
storing the information corresponding to the object as a tagged virtual world object in a database;
receiving a request from a second virtual world client;
searching a database based on the request and based on tags corresponding to virtual world objects, wherein the tags are stored in the database, wherein the searching returns at least the tagged virtual world object; and
sending virtual world objects returned by the searching, including the tagged virtual world object, to the second virtual world client.

11. A method comprising:
receiving, from a user, a command to perform an action in a virtual world;
sending a request to a search aggregation service;
receiving one or more tagged virtual world objects from the search aggregation service in response to the sending of the request; and
presenting a virtual world to the user using the one or more tagged virtual world objects.

12. The method of claim 11, further comprising:
integrating the one or more tagged virtual world objects in the virtual world to be presented to the user by accessing a virtual world server and retrieving information regarding the virtual world and information regarding the one or more tagged virtual world objects.

13. The method of claim 11, wherein the action includes performing a text-based search for one or more virtual world objects.

14. The method of claim 11, wherein the action includes navigating an avatar associated with the user to a particular location in the virtual world.

15. The method of claim 11, wherein the action includes selecting an object in the virtual world.

16. The method of claim 11, wherein the request includes virtual world object search parameters.

17. The method of claim 11, wherein the request includes a location of an avatar associated with the user in the virtual world.

18. The method of claim 11, wherein the request includes an automatic query generated by virtue of a location of an avatar associated with the user in the virtual world.

19. The method of claim 11, wherein the request includes an object identification of a virtual world object selected by the user.

20. The method of claim 11, wherein the request includes an automatic query generated by virtue of an object identification of a virtual world object selected by the user.

21. The method of claim 11, wherein the request includes a user profile for the user.

22. The method of claim 11, wherein the presenting includes presenting the one or more tagged virtual world objects as graphics in a virtual world menu.

23. The method of claim 11, wherein the presenting includes highlighting the one or more tagged virtual world objects in the virtual world.

24. The method of claim 11, wherein the presenting includes presenting customized advertisements in the virtual world based on one or more tags of the one or more tagged virtual world objects.

25. An apparatus comprising:
an interface; and
one or more processors configured to perform the following steps:
receiving, from a user, a command to perform an action in a virtual world;
sending a request to a search aggregation service;
receiving one or more tagged virtual world objects from the search aggregation service in response to the sending of the request; and
presenting a virtual world to the user using the one or more tagged virtual world objects.

26. A system comprising:
a first virtual world client;
a second virtual world client;
a virtual world server communicatively coupled to the first virtual world client and the second virtual world client;
a search aggregation service communicatively coupled to the first virtual world client and the second virtual world client, wherein the search aggregation service is configured to:
receive, from the first virtual world client, information regarding an object in a virtual world;
store the information corresponding to the object as a tagged virtual world object in a database;
receive a request from the second virtual world client;
search a database based on the request and based on tags corresponding to virtual world objects, wherein the tags are stored in the database, wherein the searching returns at least the tagged virtual world object; and
send virtual world objects returned by the searching, including the tagged virtual world object, to the second virtual world client.
